(19) United States
(12) Patent Application Publication
(10) Pub. No.: US 2011/0175296 A1
(43) Pub. Date: Jul. 21, 2011

(54) Brush Seals

(75) Inventor: Aaron Bowsher, Wiltshire (GB)

(73) Assignee: Cross Manufacturing Company (1938) Ltd, Devizes, Wiltshire (GB)

(21) Appl. No.: 12/674,317

(22) PCT Filed: Aug. 18, 2008
(86) PCT No.: PCT/GB2008/002798

§ 371 Date: Feb. 19, 2010

Related U.S. Application Data
(60) Provisional application No. 60/957,211, filed on Aug. 22, 2007.

(30) Foreign Application Priority Data
Aug. 22, 2007 (GB) 0716330.6
Apr. 12, 2008 (GB) 0806682.1

(51) Int. Cl. F16J 15/44

(52) U.S. Cl. 277/355

(57) ABSTRACT

A brush seal having bristles of a diameter of between 0.005 mm to 0.02 mm manufactured from an oxidation resistant metal alloy including between 10 and 60% cobalt as a base alloy having no more than 1% creep after a 1000 hours at 650° C. at a pressure of at least 345 Pa.

This invention relates to brush seals such as are used in gas and steam turbines. Brush seals in gas and steam turbines work under significant temperature gradients, operating temperatures and operating pressures. Many attempts have been made to find appropriate brush seal bristle materials that will operate under present conditions, but these have not been successful, because those skilled in the art have not been able to define sufficiently the criteria for such materials. In general the industry has tended to use alloys having a Cobalt base alloy, but these have a number of limitations in the present operating regimes, let alone under the higher temperature operating regimes which are proposed in both the power generation turbine industry and the aero engine industries. Further they have not been successful in meeting the seal lifetimes that are currently being projected by the customers.

The present invention consists in the brush seal having bristles of a diameter of between 0.0254 mm to 0.254 mm manufactured from an oxidation resistant metal alloy including between 10% and 60% cobalt as a base alloy and having no more than 1% creep after 1000 hours at 650° C. at a pressure of at least 551 MPa.

In preferred embodiments the alloy should have some or all of the following properties:

1. It is preferred that the metal alloy includes molybdenum or other lubricious elements and, additionally or alternatively, the alloy may include Ni, Cr, W, Ti or Al.

2. The alloy is weldable to stainless steel and in particular to common super alloys such as 718, 909 and 400 & 300 series stainless steels.

3. The alloy should not require heat treatment, after welding to a carrier, at more than 980° C. whether the heat treatment is carried out in a vacuum or in air. In the former case heat treatment above this temperature can lead to bonding of the bristles, whilst in the latter case excessive oxidation can occur.

4. The alloy should have good high and low temperature rub properties so that the seal can work well at engine start and stop as well as under operating conditions. A typical wear coefficient of 6×10⁻⁴ and a range of 5.5×10⁻⁴ to 2×10⁻³ is appropriate.

5. High hot hardness is desired, because the applicants have determined this correlates to low bristle wear. Typically 286 DHN at 650° C. and a range of 318 to 286 DHN is acceptable.

6. The bristles should have high strength so that the seal either has increased pressure capacity or can include fewer bristles. Reduced bristle numbers can be desirable because of reduced cost and reduced weight. Heat generation during operation can also be reduced in those cases. The tensile strength typically should be between 1312 to 2162 MPa at room temperature.

7. The material has to be available in small quantities at reasonable cost and needs to be capable of being drawn to achieve the bristle sizes defined above.

The applicants have determined that a key criteria for high temperature use and long life is achieving a suitable value for creep stress over a long period of time and at high temperatures. This makes the selection of materials difficult, because there is no suitable predictive theory and tests over lifetimes of, for example 100,000 hours have not taken place and, for obvious reasons, cannot be carried out in a hurry!

However, the applicants have determined a way of empirically determining the creep stress of an alloy at a particular temperature after a particular lifetime by extrapolating the known rupture data material for alloys over temperature and time so as to achieve plots of gradient and y intersect against temperature and from this they have been able to derive stress equations against life for any likely operating temperature. From this analysis and judged against the criteria listed above, they have identified alloys sold under the trademarks HAYNES™ 282, C263 as NS-163T suitable materials.

Haynes NS-163T is a cobalt based alloy having remainders-28Cr-9Mi-21Fe-1.25Ti-1Nb.

1. A brush seal having bristles of a diameter of between 0.005 mm to 0.02 mm manufactured from an oxidation resistant metal alloy including between 10 and 60% cobalt as a base alloy and having no more than 1% creep after a 1000 hours at 650° C. at a pressure of at least 345 Pa.

2. A brush seal as claimed in claim 1 wherein the metal alloy includes molybdenum or other lubricious elements.

3. A brush seal as claimed in claim 1 wherein the alloy includes one or more of Ni, Cr, W, Ti, or Al.

4. A brush seal as claimed in claim 1 wherein the alloy is weldable to stainless steel.

5. A brush seal as claimed in claim 1 wherein the bristles are welded to a carrier and heat treated post weld at a temperature below 980° C.

6. A brush seal as claimed in claim 1 wherein the alloy has a wear coefficient in the range 5.5×10⁻⁴ to 2×10⁻³.

7. A brush seal as claimed in claim 1 wherein the alloy has a hardness of between 318 to 286 DHN at 650° C.

8. A brush seal as claimed in claim 1 wherein the tensile strength is between 1312 to 2162 Mpa at room temperature.

9. A brush seal as claimed in claim 2 wherein the alloy includes one or more of Ni, Cr, W, Ti, or Al.

10. A brush seal as claimed in claim 2 wherein the alloy is weldable to stainless steel.

11. A brush seal as claimed in claim 2 wherein the bristles are welded to a carrier and heat treated post weld at a temperature below 980° C.

12. A brush seal as claimed in claim 2 wherein the alloy has a wear coefficient in the range 5.5×10⁻⁴ to 2×10⁻³.

13. A brush seal as claimed in claim 2 wherein the alloy has a hardness of between 318 to 286 DHN at 650° C.

14. A brush seal as claimed in claim 2 wherein the tensile strength is between 1312 to 2162 Mpa at room temperature.

15. A brush seal as claimed in claim 3 wherein the alloy is weldable to stainless steel.

16. A brush seal as claimed in claim 3 wherein the bristles are welded to a carrier and heat treated post weld at a temperature below 980° C.

17. A brush seal as claimed in claim 3 wherein the alloy has a wear coefficient in the range 5.5×10⁻⁴ to 2×10⁻³.

18. A brush seal as claimed in claim 3 wherein the alloy has a hardness of between 318 to 286 DHN at 650° C.

19. A brush seal as claimed in claim 3 wherein the tensile strength is between 1312 to 2162 Mpa at room temperature.
